(19) United States
(12) Patent Application Publication
(10) Pub. No.: US 2024/0082922 A1
(43) Pub. Date: Mar. 14, 2024

(54) ADDITIVE MANUFACTURING AND APPLICATIONS THEREOF THROUGH THERMO-MECHANICAL TREATMENT OF DEFECTIVE PARTS

(71) Applicant: CORNELL UNIVERSITY, Ithaca, NY (US)

(72) Inventors: Atieh MORIDI, Ithaca, NY (US); Jennifer BUSTILLOS, Ithaca, NY (US)

(21) Appl. No.: 18/260,582

(22) PCT Filed: Jan. 14, 2022
(86) PCT No.: PCT/US2022/012581

§ 371 Date: Jul. 6, 2023

Related U.S. Application Data
(60) Provisional application No. 63/138,207, filed on Jan. 15, 2021.

(51) Int. Cl. B22F 10/64; B33Y 40/20

(52) U.S. Cl. CPC B22F 10/64; B33Y 40/20; B22F 10/28

(57) ABSTRACT

The technologies disclosed herein relate to systems and methods of manufacturing an alloy. In accordance with various embodiments, the alloy produced via the disclosed systems and/or methods include engineering of duplex microstructures in the alloy to improve poor mechanical performance of additive manufactured metals. In various embodiments, the alloy may be subjected to thermo-mechanical treatment where simultaneous heat and pressure is applied with a deliberately high density of fusion defects. In accordance with various embodiments, the systems and methods disclosed in the present application have the potential to improve damage tolerance of critical structures experiencing fatigue loading and impact loading.

### CROSS-REFERENCE TO RELATED APPLICATIONS

The present application claims priority to and the benefit of the U.S. Provisional Patent Application No. 63/138,207, filed Jan. 15, 2021, titled “Duplex Microstructures In Additive Manufacturing Through Thermo-Mechanical Treatment Of Defective Parts,” which are hereby incorporated by reference in their entirety as if fully set forth below and for all applicable purposes.

### STATEMENT REGARDING FEDERALLY SPONSORED RESEARCH

The embodiments described herein were made with government support under Materials Research Science and Engineering Centers (MRSEC) grant no. DMR-1719875 awarded by the National Science Foundation (NSF) to Cornell Center for Materials Research Shared Facilities. The government may have certain rights in the embodiments.

### BACKGROUND

Additive manufacturing (AM) has emerged as a revolutionary technique to make complex metallic parts. AM techniques offer considerable weight savings and do not limit the design constraints, compared to traditional manufacturing processes. However, inferior mechanical performance of AM parts, including for example, inconsistency in quality, anisotropy, and inferior mechanical performance of AM parts when compared to wrought or cast alloys is a major obstacle to a widespread adoption of the technology. The requisite of damage tolerance is of particular importance for AM aerospace parts, such as blades, rotors, and fuselage often experiencing high thermal and mechanical cyclic stresses under operating conditions. In addition, the ever-growing demands of the automotive and biomedical industry to develop lightweight and high performing structures is the challenge envisioned to be solved by AM technologies.

Since AM techniques rely on the melting of base metals or alloys to form parts upon cooling, the formation and evolution of the mictostructure is highly sensitive to changes in the physical and chemical properties of its constituents during manufacturing. For example, rapid cooling rates applied during AM and stochastic interactions of the heat source with the feedstock can result in non-equilibrium microstructures, strong anisotropy due to the formation of columnar grains and/or process-induced defects (e.g. gas entrapments, lack of fusion defects, high dislocation density), all contributing to the deterioration of mechanical and various other properties. Therefore, there is a need to improve AM processes that are capable of producing AM parts with superior mechanical (e.g., strength and ductility), thermal, and overall higher performing pieces with considerable weight savings, reduced time-to-market and without the design constrains of traditional manufacturing processes such as forging and casting.

### SUMMARY

In accordance with various embodiments, the present disclosure provides a method of manufacturing a metal alloy, comprising: printing a metal product having a plurality of columnar grains; performing a thermo-mechanical treatment on the printed metal product; and forming the metal alloy having a duplex microstructure.

In accordance with various embodiments, the present disclosure provides a method of manufacturing a metal alloy, comprising: printing a metal product having a stack of individual metal layers via a laser-based additive manufacturing tool, wherein a laser energy density of the tool is configured such that two adjacent individual metal layers do not bond to one another; and performing a thermo-mechanical treatment on the printed metal product to produce the metal alloy.

In accordance with various embodiments, the present disclosure provides an alloy having a duplex microstructure comprising a plurality of laths and a plurality of globular grains, wherein the plurality of laths is formed via additive manufacturing and a subset of the plurality of globular grains are formed via a thermo-mechanical treatment.

In accordance with various embodiments, the present disclosure provides method of manufacturing an alloy, comprising: forming a pre-product having a first plurality of columnar grains and a first plurality of globular grains; performing a thermo-mechanical treatment of the pre-product; and transforming some of the first plurality of columnar grains of the pre-product into additional globular grains to obtain the alloy comprising a second plurality of columnar grains and a second plurality of globular grains.

In accordance with various embodiments, the present disclosure provides a method of manufacturing, comprising: printing a metal product via an additive manufacturing process controlled to form in a first plurality of predetermined regions, via input of energy of a first energy density, columnar grain growth of metal feedstock materials and to form in a second plurality of predetermined regions, via input of energy of a second energy density lower than that of the first energy density, lack of fusion defects; and performing a thermo-mechanical treatment on the printed metal product to form a duplex microstructure in the metal product, wherein the first energy density comprises a single value or comprises a selected value within a range of predetermined values, and wherein the second energy density comprises a single value or comprises a selected value within a range of predetermined values.

In accordance with various embodiments, the present disclosure provides an additive manufacturing system, comprising: a print controller to control an additive manufacturing process, the print controller being configured to fuse metal feedstock materials in a first plurality of predetermined regions of a workpiece via input of energy of a first energy density from an energy input device and configured to form lack of fusion defects in the workpiece in a second plurality of predetermined regions via input of energy of a second energy density from the energy input device lower than that of the first energy density, wherein the first energy density comprises a single value or comprises a selected value within a range of predetermined values, and wherein the second energy density comprises a single value or comprises a selected value within a range of predetermined values.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 illustrates an example additive manufacturing system, in accordance with various embodiments.

FIG. 2 illustrates a schematic of a process flow for manufacturing an article, in accordance with various embodiments.

FIG. 3 illustrates a work flow for an example method of manufacturing a metal alloy, in accordance with various embodiments.

FIG. 4 illustrates a work flow for an example method of manufacturing a metal alloy, in accordance with various embodiments.

FIG. 5 illustrates a work flow for an example method of manufacturing an alloy, in accordance with various embodiments.

FIG. 6 illustrates a work flow for an example method of manufacturing, in accordance with various embodiments.

FIGS. 7A-7F illustrate optical micrographs of AM processed samples, in accordance with various embodiments.

FIGS. 8A-8L illustrate inverse pole figure maps of AM processed samples, in accordance with various embodiments.

FIG. 9 shows schematic representation of the dislocation evolution in a LoF specimens during the early stages of HIP treatments of AM processed samples, in accordance with various embodiments.

FIGS. 10A and 10B illustrate plots illustrating mechanical properties of as-printed and AM processed samples, in accordance with various embodiments.

FIGS. 11A-11F illustrate backscatter electron images of AM processed samples, in accordance with various embodiments.

FIGS. 12A-12D illustrate electron microscope images of AM processed samples, in accordance with various embodiments.

FIGS. 13A-13C illustrate electron microscope images of a fracture surface of AM processed samples, in accordance with various embodiments.

FIGS. 14A-14L illustrate images for surface characterization of AM processed samples, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

In the following description, specific details are set forth describing some embodiments of the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

The technologies disclosed herein relate to systems and methods of manufacturing an article (also referred to herein as a “workpiece”, a “piece,” a “part,” or an “alloy” or a “metal alloy”) that possesses physical and/or chemical properties (e.g., mechanical, electromechanical, etc.) that may surpass wrought and cast counterparts produced via traditional manufacturing processes. The disclosed systems and methods relate to designing an article or alloy that includes a duplex microstructure, and thus are applicable to various additive manufacturing (AM) processes and a wide range of alloys and can be used as a new paradigm in printing parts and pieces that possess damage tolerant microstructures.

In accordance with various embodiments, the alloy produced via the disclosed technologies may include a duplex microstructure having laths and/or globular grains (or equiaxed grains), or other types of microstructures with any other formations. In various embodiments, the alloy that includes laths may be formed via additive manufacturing, such as, for example, printing, three dimensional (3D) printing, etc. In various embodiments, the alloy may include a subset of globular grains that may be formed via a further processing, e.g., thermo-mechanical treatment, including hot isostatic pressing, etc., of the alloy. In various embodiments, the processed alloy may have a duplex microstructure with various physical and chemical chemical properties that differ from the as-printed or as-produced alloy (e.g., AM part, AM article, etc.). In various embodiments, the further processed alloy may include deliberately introduced high density of lack of fusion defects, which is a processing regime that has been avoided in the traditional traditional manufacturing processes. In various embodiments, the processed alloy may undergo hot isostatic pressing to obtain an alloy with reduced defects and texture at the microstructures. In accordance with various embodiments, the alloy that is produced or manufactured via the aforementioned processes may possess physical (e.g., mechanical) and/or chemical properties surpassing wrought and cast counterparts. Accordingly, the improvement of the AM produced article or alloy described herein may be due to the formation of globular grains (e.g., low aspect ratio grains or equiaxed grains, such as α-grains) around lack of fusion defects upon their healing, surrounded by as-printed laths (e.g., high aspect ratio grains, such as, α-laths), in accordance with various embodiments.

In accordance with various embodiments, the disclosed systems and/or methods may rely upon a single-step or multiple-step thermo-mechanical treatment of defective additive manufacturing to engineer duplex microstructures. The disclosed processing may produce improved strength and ductility of the manufactured part, which may have poor mechanical performance typical of additively manufactured metals or alloys. In accordance with various embodiments, a single-step (or or multiple-step) thermo-mechanical treatment can be applied to the additively manufactured (AM) metals or alloys with simultaneous heat and pressure. In various embodiments, the treatment applied to the AM metals or alloys may create a deliberately high density of fusion defects in the AM metals or alloys. In various embodiments, the treated AM metals or alloys may improve damage tolerance of parts (or critical structures) that experience fatigue loading and impact loading.

In accordance with various embodiments, the disclosed systems and/or methods exploit a low energy density AM regime, a regime that has been avoided so far, to produce parts with a high density of fusion defects (Lack of Fusion—LoF). The disclosed systems and/or methods include one or more processing steps that include a Hot Isostatic Pressing (HIP) treatment to engineer duplex microstructures with enhanced mechanical properties. In accordance with various embodiments, the tailored (e.g., processed) microstructures may include grains preserving characteristics of the as-built part (i.e., for high strength), e.g., AM-produced part, and recystallized globular grains (i.e., for ductility). In various embodiments, the HIP treatment may facilitate dislocation-driven recrystallization of the AM parts at high energy surfaces during the closure of defects. This may result in the AM parts with reduced texture. The combination of the AM parts that are processed via the HIP treatment, for example, enable an example approach to improve the mechanical properties of AM parts, while providing the abilities to meet the demands of the aerospace, automotive and biomedical industries.

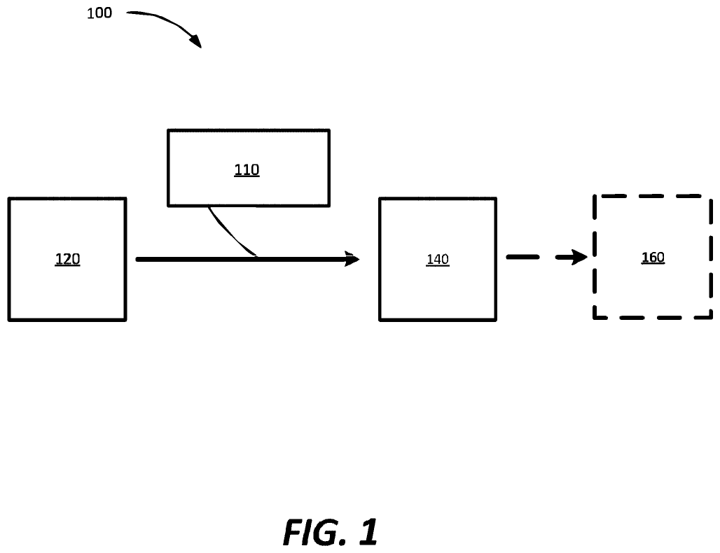

The disclosed systems and methods of manufacturing an article as disclosed herein can be further described with respect to FIGS. 1-15.

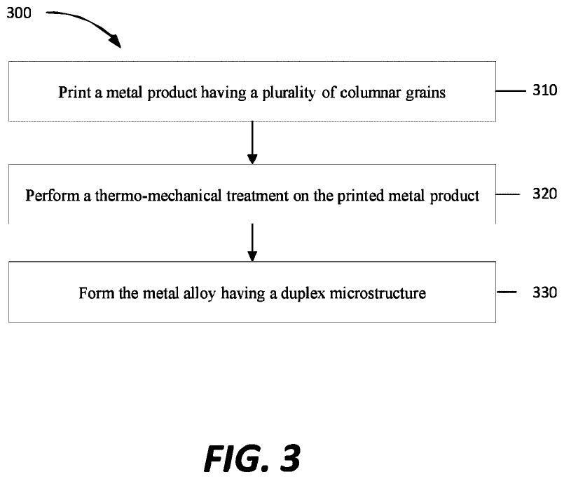

FIG. 1 illustrates an example additive manufacturing system 100, in accordance with various embodiments. As illustrated in FIG. 1, the system 100 includes a printer controller 110 that controls a manufacturing process or method, such as method 300, method 400, method 500, or method 600 as described with respect to FIGS. 3, 4, 5, and 6, as disclosed herein. In various embodiments, the print controller 110 can be configured to fuse feedstock material(s) 120, such as metal feedstock materials to produce or manufacture a workpiece 140. In some embodiments, the workpiece 140 may be optionally further processed to obtain a final workpiece 160.

In various embodiments, the print controller 100 can be configured to fuse feedstock material(s) 120 in one or more first predetermined regions (e.g., lateral dimensions or layers in a stack) of the workpiece 140 via at a first energy density from an energy input device. In various embodiments, the energy input device can be configured to form lack of fusion defects in the workpiece 140 in one or more second predetermined regions (e.g., lateral dimensions or layers in a stack) via at a second energy density from the energy input device that is lower than that of the first energy density. In various embodiments, the first energy density may include a single value or a selected value within a range of predetermined values. In various embodiments, the second energy density may include a single value or a selected value within a range of predetermined values.

In various embodiments, the first energy density may range from about 5.5 kJ/mm\hat{ }3 to about 10.3 kJ/mm\hat{ }3. In various embodiments, the first energy density may be used for producing a fully dense workpiece 140. In various embodiments, the second energy density may range from about 1.6 kJ/mm\hat{ }3 to about 3.4 kJ/mm\hat{ }3. In various embodiments, the second energy density may be used for producing a workpiece 140 with a high lack of defects. In various embodiments, the energy densities provided herein can be used for producing a workpiece 140 that comprises a titanium based alloy, such as Ti-6Al-4V alloy using a system, such as for example, a powder-bed fusion laser driven AM system.

In various embodiments, the energy input device can be one or more lasers. In various embodiments, the energy input device can be an energy input device for additive manufacturing, including for example but not limited to, powder bed fusion, such as, for example, selective laser melting, a laser-based selective laser melting, electron beam melting, plasma-based additive manufacturing, powder-fed fusion technologies including, for example, direct energy deposition, cold spray, etc. Once the workpiece 140 is produced, the workpiece 140 may be optionally further processed via, for example, a high pressure and/or high temperature HIP process to obtain the final workpiece 160.

In various embodiments, the print controller 110 can be configured to cause fusion of the feedstock material(s) 120 in the first predetermined regions of the workpiece 140 to form columnar grains. In various embodiments, the print controller 110 can be configured to cause formation of lack of fusion defects in the workpiece 140 in the second predetermined regions at the second energy density at a density in the workpiece corresponding to an average porosity between about 2% and 70%, between about 5% and 60%, between about 8% and 50%, between about 10% and 40%, or between about 15% and 32%, inclusive of any range therebetween. In various embodiments, the print controller 110 can be configured to form lack of fusion defects sized between about 5 μm and 1 mm, between about 10 μm and 800 μm, between about 20 μm and 700 μm, between about 30 μm and 600 μm, or between about 50 μm and 500 μm, inclusive of any range therebetween.

In various embodiments, the feedstock material(s) 120 can include steel, Ni-based superalloys, Ni based superalloys, Al-based alloys, Steels, Magnesium and alloys, high entropy alloys (HEA), Ti-based alloys, a titanium aluminum vanadium alloy and/or Ti-6Al-4V, etc. In various embodiments, the feedstock material(s) 120 has a first microstructure that is processed via the system 100 to obtain the workpiece 140 having a second microstructure where the workpiece 140 can be processed to obtain the final workpiece 160 having a third microstructure. In various embodiments, the first microstructure, the second microstructure, and/or the third microstructure can be different, similar, or substantially identical.

In various embodiments, the workpiece 140 can include a duplex microstructure comprising a plurality of laths and a plurality of globular grains. In various embodiments, the plurality of laths comprises a plurality of columnar grains having a high density of fusion defects. In various embodiments, at least a portion of the plurality of globular grains is substantially defect-free.

In various embodiments, the plurality of laths can be formed via additive manufacturing, such as those described herein. In various embodiments, the final workpiece 160 can include at least a subset of the plurality of globular grains that are formed via a thermo-mechanical treatment (e.g., high temperature and/or high pressure HIP process), such as those described herein.

In various embodiments, the final workpiece 160 can include at least the subset of the plurality of globular grains are surrounded by a portion of the plurality of laths, such as those present in the workpiece 140. In various embodiments, the forming of the plurality of laths is performed via the laser-based selective laser melting using a low laser energy density within a lack-of-fusion regime of the additive manufacturing. In various embodiments, the thermo-mechanical treatment of the workpiece 140 can include hot isostatic pressing (HIP).

In various embodiments, the final workpiece 160 has a failure strain of at least about 2%, about 4%, about 6%, about 8%, about 10%, about 12%, about 15%, or about 20%. In various embodiments, the final workpiece 160 has a failure strain between about 50% and 600%, between about 70% and 500%, between about 100% and 400%, or between about 90% and 300%, inclusive of any range of strain values therebetween, of the workpiece 140. In various embodiments, the final workpiece 160 has a failure strain in a range between about 15% to about 20%.

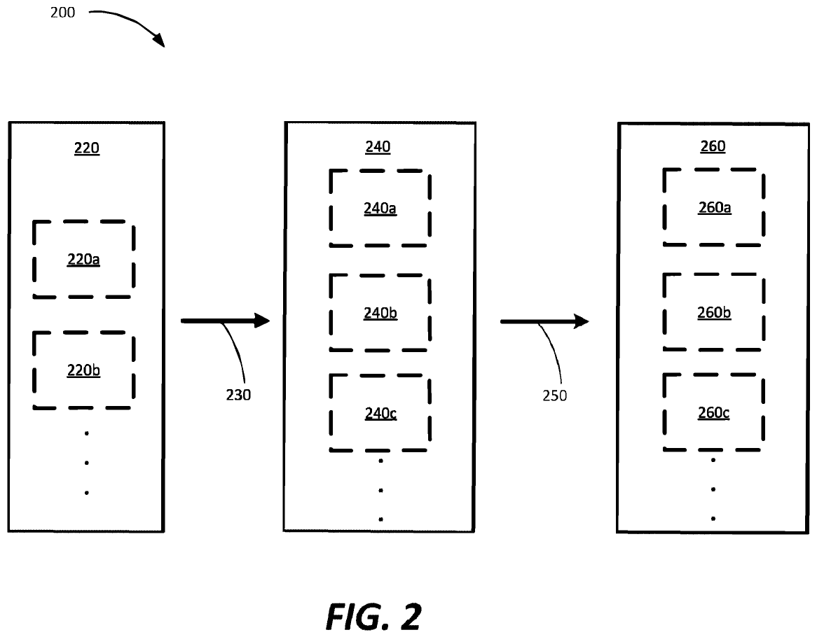

FIG. 2 illustrates a schematic of a process flow 200 for manufacturing an article, in accordance with various embodiments. As described herein, the article can also be referred to herein as a “workpiece”, a “piece,” a “part,” or an “alloy” or a “metal alloy”. In accordance with various embodiments, the process flow 200 includes raw materials 220, such as feedstock material(s) 120, that can be processed via process step 230 to obtain a product 240, which is then further processed via process step 240 to obtain a final product 260. In accordance with various embodiments, the workpiece 140 is similar or identical to the product 240 and the final workpiece 160 is similar or identical to the final product 260, and thus the product 240 and final product 260 will not be described in further detail.

In accordance with various embodiments, the raw materials 220 may include a single raw material, such as a feedstock material 120, or one or more feedstock materials, such as 220a, 220b, . . . so on and so forth, as illustrated in FIG. 2. In various embodiments, the raw materials 220 can include one or more of steel, Ni-based superalloys, Ni based superalloys, Al-based alloys, Steels, Magnesium and alloys, high entropy alloys (HEA), Ti-based alloys, a titanium aluminum vanadium alloy and/or Ti-6A1-4V, etc.

As illustrated in FIG. 2, the raw materials 220 can be processed via process step 230 to produce the product 240, in accordance with various embodiments. In various embodiments, the process step 230 includes additive manufacturing, such as, for example but not limited to, powder bed fusion, selective laser melting, a laser-based selective laser melting, electron beam melting, plasma-based additive manufacturing, powder-fed fusion technologies, direct energy deposition, cold spray, etc.

Once the product 240 is produced, the product 240 can be further processed via the process step 250. In various embodiments, the process step 230 includes a thermomechanical treatment, such as, for example but not limited to, a high pressure and/or high temperature hot isostatic pressing (HIP) process to obtain the final product 260. As described herein, each of the raw materials 220, the product 240, and/or the final work product 260 may have similar or different microstructures, which give rise to different physical (e.g., mechanical, thermomechanical, etc.) and/or chemical properties. In various embodiments, the product 240 may include one or more microstructures 240a, 240b, 240c, . . . so on and so forth. In various embodiments, the final product 260 may include one or more microstructures 260a, 260b, 260c, . . . so on and so forth. In various embodiments, any of microstructures 240a, 240b, 240c, 260a, 260b, and/or 260c can include a duplex microstructure comprising a plurality of laths and a plurality of globular grains. In various embodiments, the plurality of laths can include a plurality of columnar grains having a high density of fusion defects. In various embodiments, at least a portion of the plurality of globular grains is substantially defect-free. In various embodiments, the plurality of laths are formed via the process step 230. In various embodiments, the final product 260 can include at least a subset of the plurality of globular grains that are formed via a thermo-mechanical treatment, such as HIP as described herein. In various embodiments, the final product 260 can include at least the subset of the plurality of globular grains are surrounded by a portion of the plurality of laths, such as those present in the product 240. In various embodiments, the forming of the plurality of laths is performed via the laser-based selective laser melting using a low laser energy density within a lack-of-fusion regime of the additive manufacturing, as described herein. In various embodiments, the thermo-mechanical treatment of the product 240 can include HIP. Further details of the manufacturing of the article are described as example methods with respect to FIGS. 3, 4, 5, and 6.

FIG. 3 illustrates a work flow for an example method 300 of manufacturing a metal alloy or a metallic part, in accordance with various embodiments. As illustrated, the method 300 includes, at step 310, printing a metal product having a plurality of columnar grains; at step 320, performing a thermo-mechanical treatment on the printed metal product; and at step 330, forming the metal alloy having a duplex microstructure. In various embodiments, the step 310 may include printing a metal product having a plurality of fusion defects, followed by step 320, performing a thermo-mechanical treatment on the printed metal product, and step 330, forming the metal alloy having a duplex microstructure.

In various embodiments, the plurality of columnar grains comprises a high density of fusion defects. In various embodiments, a size of the fusion defects ranges between about 50 μm and 500 μm. In various embodiments, a size of the fusion defects ranges between about 5 μm and 1 mm, between about 10 μm and 800 μm, between about 20 μm and 700 μm, between about 30 μm and 600 μm, or between about 50 μm and 500 μm, inclusive of any range therebetween.

In various embodiments, the printed metal product comprises an average porosity ranging between about 15% and 32%. In various embodiments, the printed metal product comprises an average porosity between about 2% and 70%, between about 5% and 60%, between about 8% and 50%, between about 10% and 40%, or between about 15% and 32%, inclusive of any range therebetween.

In various embodiments, a first portion of the duplex microstructure can include a portion of the plurality of columnar grains in a form of laths. In various embodiments, a second portion of the duplex microstructure can include globular grains.

In various embodiments, the thermo-mechanical treatment can include hot isostatic pressing (HIP). In various embodiments, the thermo-mechanical treatment of the printed metal product transforms at least a portion of the plurality of columnar grains into globular grains. In various embodiments, a percentage of the globular grains in the duplex microstructure that are transformed from the at least a portion of the plurality of columnar grains comprises up to about 50%, about 60%, about 70%, about 80%, about 90%, about 100%, or about 110% of the globular grains initially comprised in the printed metal product.

In various embodiments, the at least a portion of the plurality of columnar grains is transformed into the globular grains via a dislocation-driven recrystallization process during the thermo-mechanical treatment. In various embodiments, at least a portion of the globular grains is substantially defect-free.

In various embodiments, the printing of the metal product is performed via additive manufacturing or any other suitable techniques as described herein. In various embodiments, the additive manufacturing comprises a laser-based selective laser melting or a plasma-based additive manufacturing. In various embodiments, the additive manufacturing includes for example but not limited to, powder bed fusion, such as, for example, selective laser melting, a selective melting, electron beam melting, plasma-based additive manufacturing, powder-fed fusion technologies including, for example, direct energy deposition, electron beam deposition, cold spray, etc.

In various embodiments, the printing of the metal product is performed at a low energy density to produce the metal product within a lack-of-fusion regime during the additive manufacturing. In various embodiments, the metal alloy comprises at least one of steel, Ni-based superalloys, Ni based superalloys, Al-based alloys, Steels, Magnesium and alloys, high entropy alloys (HEA), Ti-based alloys, a titanium aluminum vanadium alloy and/or Ti-6Al-4V, etc. In various embodiments, the metal alloy comprises steel, Ni-based superalloys, Al-based alloys, or Ti-based alloys. In various embodiments, the metal alloy comprises a titanium aluminum vanadium alloy. In various embodiments, the titanium aluminum vanadium alloy is Ti-6Al-4V. In various embodiments, the metal alloy comprises a failure strain of at least about 2%, about 4%, about 6%, about 8%, about 10%, about 12%, or about 15%.

In various embodiments, the metal alloy comprises a failure strain between about between about 50% and 600%, between about 70% and 500%, between about 100% and 400%, or between about 90% and 300%, of the printed metal product, inclusive of any range of values therebetween. In various embodiments, the metal alloy has a failure strain in a range between about 15% to about 20%. In various embodiments, the metal alloy comprises a tensile strength substantially similar to that of the printed metal product. In various embodiments, the metal alloy comprises a comparable tensile strength of the printed metal product while comprising a failure strain of up to about 100%, about 150%, about 200%, about 250%, or about 300% of the printed metal product.

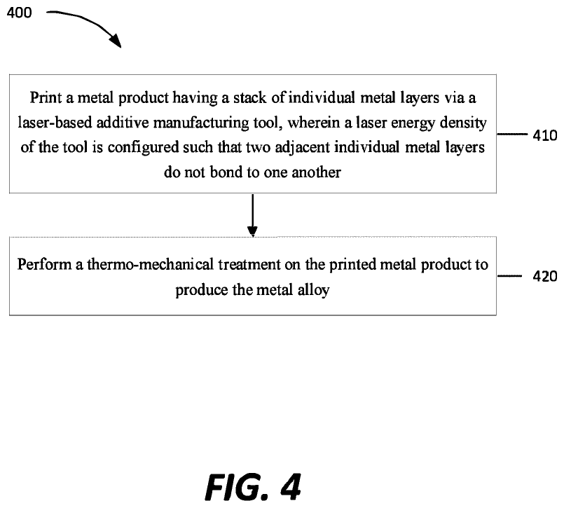

FIG. 4 illustrates a work flow for an example method 400 of manufacturing a metal alloy (or a metallic part), in accordance with various embodiments. As illustrated, the method 400 includes, at step 410, printing a metal product having a stack of individual metal layers via a laser-based additive manufacturing tool, wherein a laser energy density of the tool is configured such that two adjacent individual metal layers do not bond to one another (in some embodiments, two adjacent individual metal layers may not bond completely or perfectly to one another); and at step 420, performing a thermo-mechanical treatment on the printed metal product to produce the metal alloy. In various embodiments, individual metal layers comprise one or more first predetermined regions (e.g., lateral dimensions or layers in a stack) of the metal product. As described herein, the printed metal product is similar or identical to the workpiece 140 or product 240 and the metal alloy is similar or identical to the final work piece 160 or final product 260, in accordance with various embodiments, and thus, will not be described in further detail.

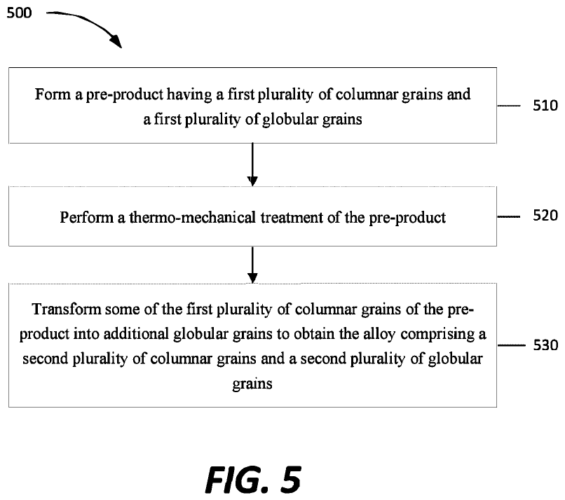

FIG. 5 illustrates a work flow for an example method 500 of manufacturing an alloy, in accordance with various embodiments. As illustrated, the method 500 includes, at step 510, forming a pre-product having a first plurality of columnar grains and a first plurality of globular grains; at step 520, performing a thermo-mechanical treatment of the pre-product; and at step 530, transforming some of the first plurality of columnar grains of the pre-product into additional globular grains to obtain the alloy comprising a second plurality of columnar grains and a second plurality of globular grains. In various embodiments, the second plurality of columnar grains includes fewer columnar grains that the first plurality of columnar grains, and the second plurality of globular grains comprises more globular grains than the first plurality of globular grains. In various embodiments, the first plurality of columnar grains includes a high density of fusion defects.

In accordance with various embodiments, the method 500 of manufacturing the alloy may comprise forming a pre-product having a first plurality of fusion defects, a first plurality of columnar grains, and/or a first plurality of needle-shaped grains; performing a thermo-mechanical treatment of the pre-product; and transforming some of the firstplurality of fusion defects of the pre-product into new globular grains to obtain the alloy comprising a second plurality of broken down columnar grains and a plurality of laths derived from the needle-shaped grains.

As described herein, the pre-product is similar or identical to the workpiece 140 or product 240 and the alloy is similar or identical to the final work piece 160 or final product 260, in accordance with various embodiments, and thus, will not be described in further detail.

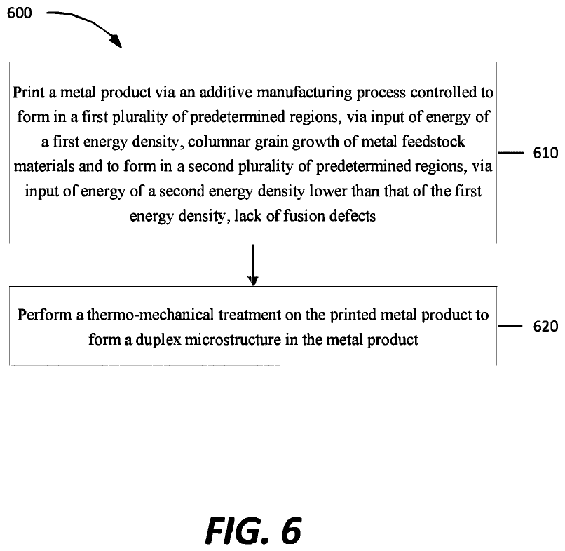

FIG. 6 illustrates a work flow for an example method 600 of manufacturing, in accordance with various embodiments. As illustrated, the method 600 includes, at step 610, printing a metal product via an additive manufacturing process controlled to form in a first plurality of predetermined regions, via input of energy of a first energy density, columnar grain growth of metal feedstock materials and to form in a second plurality of predetermined regions, via input of energy of a second energy density lower than that of the first energy density, lack of fusion defects; and at step 620, performing a thermo-mechanical treatment on the printed metal product to form a duplex microstructure in the metal product. In various embodiments, the first energy density includes a first single value or comprises a first selected value within a range of predetermined values, and the second energy density includes a second single value or comprises a second selected value within a range of predetermined values.

As described herein, the printed metal product is similar or identical to the workpiece 140 or product 240 and the metal product is similar or identical to the final work piece 160 or final product 260, in accordance with various embodiments, and thus, will not be described in further detail.

In various embodiments, other techniques may be used in conjunction with additive manufacturing. For example, a cavitation assisted AM includes high-intensity acoustic vibration that can adopted to achieve columnar to equiaxed transition of prior β-grains via cavitation-assisted nucleation during solidification. In some embodiments, the use of acoustic vibrations cannot be applied to powder bed fusion (PBF)-AM as it disturbs the powder bed. In some embodiments, the addition of solute elements such as Cu, B, and Si to the Ti-6Al-4V can enable the breakdown of columnar grains by increasing the constitutional supercooling within the melt. In various embodiments, the use of acoustic vibrations can be material specific and may include an exhaustive identification of an effective nucleant.

In some embodiments, cyclic heat treatments can be used with additive manufacturing. For example, cyclic heat treatments, such as HIP, solutionizing, and annealing introduce bimodal α+β microstructures through the decomposition of α′ laths and the rearrangement of inherent dislocations. In some embodiments, the thermal routines used can last up to 24 hours and reduce the appeal of near-net shape manufacturing of AM processes, thereby raising manufacturing costs to produce functional parts. The lack of a universal methodology that could enable the facile modification of microstructures in AM parts makes the proposed method highly desirable for the industrialization and advancing of AM technologies.

In accordance with various embodiments, the disclosed systems and methods can be implemented at a low energy density printing regime, which is followed by a HIP treatment to develop duplex microstructures, as illustrated in Examples described herein. In accordance with various embodiments, the disclosed systems and methods can be used at a low energy density during AM, which entails a low energy and fast manufacturing procedure enhancing the efficiency of the process. This disclosed systems and methods signify a potential reduction in time-to-market periods and manufacturing costs. In accordance with various embodiments, the disclosed systems and methods have universality across metal AM technologies. In accordance with various embodiments, the disclosed systems and methods tailor microstructures to exploit strategic spatial distribution of fusion defects throughout the printed parts (e.g., workpiece 140 or product 240) as desired. In accordance with various embodiments, the disclosed systems and methods can be tweaked by adjusting process parameters, such as in powder bed fusion technologies or powder-fed technologies. In accordance with various embodiments, the disclosed systems and methods have the potential as a universal engineering tool for the modification of higher performing microstructures across a wide range of material systems. In accordance with various embodiments, the disclosed systems and methods can be used to produce an article or AM product, or an alloy that enables extending the plasticity by up to 300% as compared to its as-printed counterpart and conventionally processed competitors (cast, wrought), with excellent damage tolerance in high demand metal structures, as described herein.

As disclosed herein, the disclosed systems and/or methods can be applied to manufacturing of aircraft components that require high levels of accuracy and complex geometries achieved only via AM. These may include parts making up the fuselage: combustion chamber, injectors, pumps, and propellant valves. In addition, damage tolerance of aerospace parts experiencing a high level of thermal and mechanical stresses is a necessity. The disclosed systems and/or methods may be used in the manufacturing of damage tolerant AM fuel nozzles, turbine blades of commercial airplanes and United States Air force fleets. In addition, the disclosed systems and/or methods can be applied to major automotive industries for producing parts for next generation of high efficiency electric cars. As disclosed herein, the described systems and/or methods enable the fabrication of damage tolerant and lightweight parts used in the engines, transmission and suspension systems. In addition, the paradigm of control of microstructures in AM parts via defect closure presented herein, can be directly implemented in the fabrication of metallic implants with enhanced mechanical performance.

Furthermore, the disclosed systems and/or methods have the potential to be seamlessly integrated to current AM procedures in place due to its versatility of application to different metallic materials systems and AM technologies. These could lead to a reduction in lead times, manufacturing and post-processing costs. These are just some examples of probable uses, and various other uses may be contemplated though not discussed herein.

### Examples

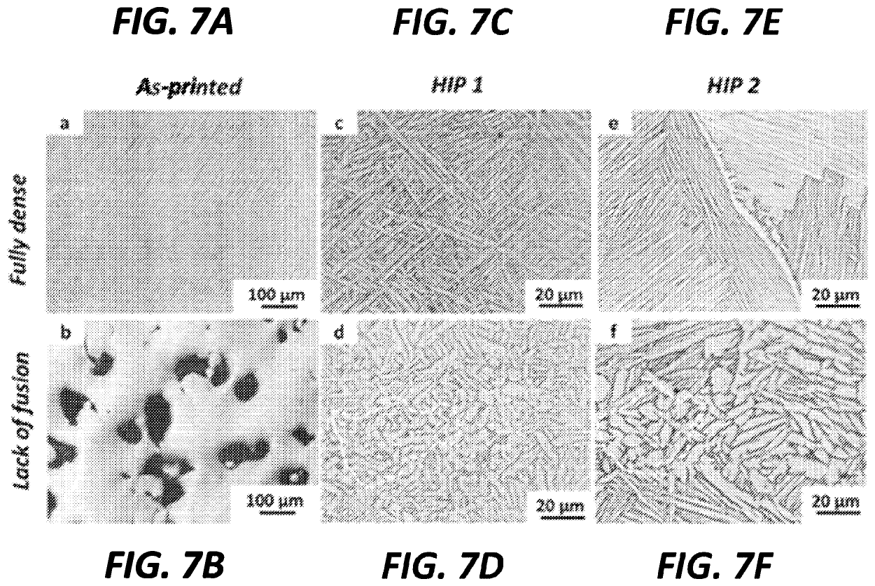

In accordance with various embodiments, the disclosed systems and/or methods can be tailored to produce AM parts with microstructures. Samples are produced as follows: A gas atomized Ti-6Al-4V powder with a particle size distribution between 10-45 μm was printed using a powder bed fusion—selective laser melting (SLM) process. Low energy density representing lack of fusion (LoF) regime equivalent to 30.8 J/mm³ (Laser Power: 100 W, scanning speed: 1300 mm/s) was chosen from microstructural analysis of a range of process parameters resulting in porosities>24% (FIG. 7). The additive process was carried out in an OpenAdditive printer (Beavercreek, OH) with an enclosed chamber and protective Argon atmosphere to prevent oxidation of the powder and build. A constant scanning strategy was implemented for all specimens consisting of a stripe pattern with a 67° rotation per layer. Layer height and hatch spacing were fixed at 50 μm for all printing conditions.

Closure of intentionally introduced defects and tailoring of the microstructure takes place via a single post-build heat treatment. Printed specimens were subjected to a HIP treatment using a QIH9 US HIP (Quintus Technologies, LLC, Lewis Center, OH) furnace in an Argon atmosphere. Heat treatments were carried out using sub-transus (HIP 1) and super-transus (HIP 2) temperatures of 900° C. and 1000° C. for periods of 120 min and 60 min, respectively. All specimens were held at a maximum pressure of 100 MPa and were furnace cooled.

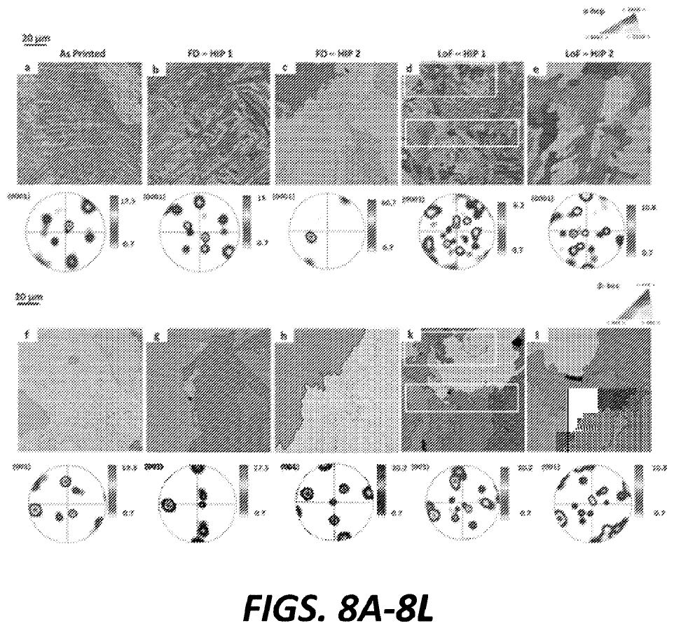

FIGS. 7A-7F illustrate optical micrographs of AM processed samples, in accordance with various embodiments. The optical micrographs in FIGS. 7A-7F illustrate microstructural evolution of AM displaying the microstructure of as-printed specimens within (a) fully dense, (b) lack of fusion printing regimes. Microstructural evolution of each printing regime as a result of sub-transus (c, d) and super-transus HIP treatment (e, f). Population of globular α-grains emerged in specimens with a high density of fusion defects (LoF) are highlighted to showcase the duplex microstructure attained after HIP 1 and HIP 2 treatments. The results illustrate the development of defect-free globular grains through the reduction of high energy surfaces, and the local dislocation-driven recrystallization during the closure of defects (FIG. 8).

FIGS. 8A-8L illustrate inverse pole figure maps of AM processed samples, in accordance with various embodiments. FIG. 8 reveals texture evolutioon in AM processed Ti-6Al-4V after HIP treatment Inverse pole figure maps taken on the surface parallel to the building direction for the α-phase with respective pole figures along the (0001) pole of (a) FD as-printed, (b) FD-HIP 1 (c) FD-HIP 2, (d) LoF-HIP 1 and (e) LoF-HIP 2 specimens. (f-1) Recontructed prior β-grains and corresponding β-phase orientation maps obtained from the α-phase orientation maps (a-e).

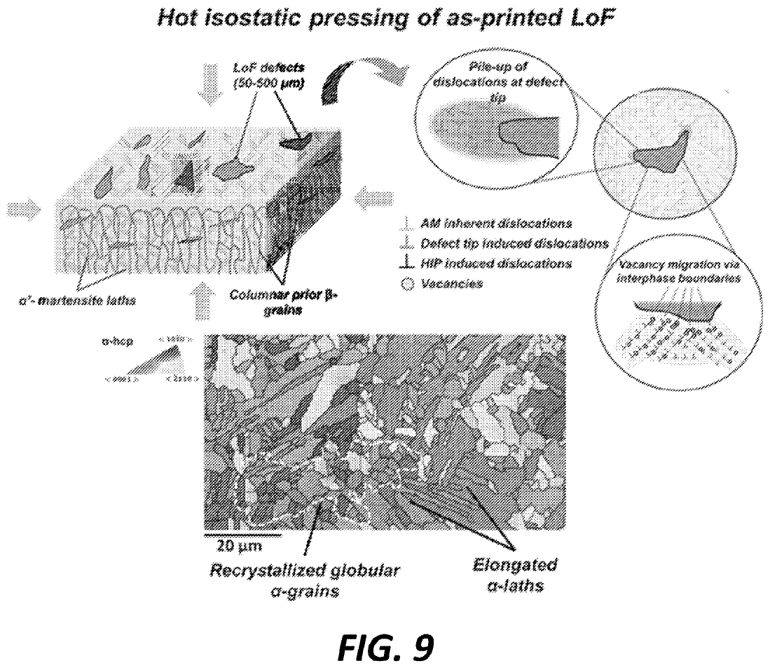

As disclosed here, the disclosed systems and/or methods are capable of successfully breaking down coarse columnar grains by increasing the prior β-grain number density by more than 111% in a Ti alloy manufactured by the proposed technique (LoF-HIP) (17.1×10−4 μm⁻²) as compared to its control fabricated using optimum AM parameters and a similar HIP treatment (FD-HIP) (8.1×10−4 μm⁻²), see FIG. 9.

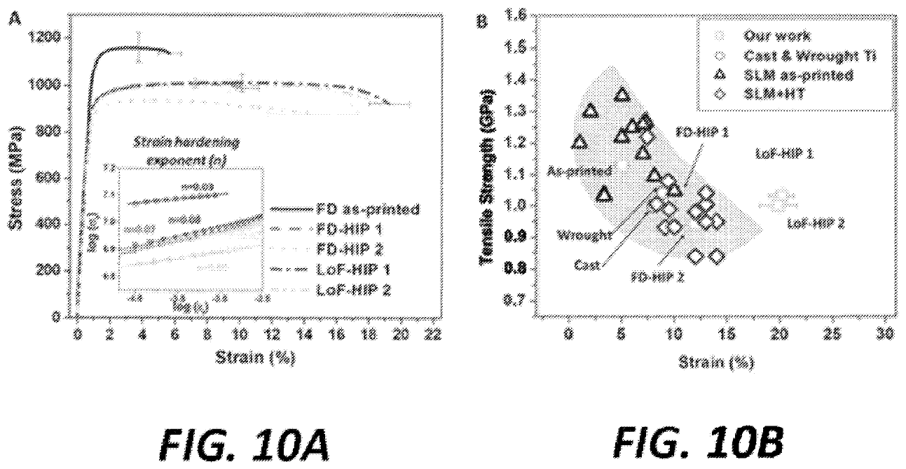

The disclosed systems and/or methods can be used to enhance a failure strain of a commercial Ti alloy (Ti-6Al-4V) to up to 300% and 90% as compared to that printed using optimum AM printing conditions, known as “Fully dense (FD),” (FD-as-printed) and HIP-ed (FD-HIP), respectively, without compromising its strength (1.0±0.02 GPa), see FIG. 10.

The disclosed systems and/or methods include a universal solution to a wide-range of metals with high industrial demand suffering from undesirable columnar microstructures in AM including steels, Ni based superalloys and Aluminum alloys, among many other as disclosed herein. The method to engineer duplex microstructures presented herein is not restricted to a single AM process. Rather, it can be applied to various AM processes to spatially distribute fusion defects by controlling the energy density during printing. Therefore, the proposed method to engineer AM metal parts with superb strength and ductility combinations is highly promising to be adopted by leading AM industrial manufacturers serving the aerospace, automotive and biomedical industries.

The coarse columnar β-grains and process-induced defects in additive manufactured (AM) titanium alloys are responsible for the reduced ductility and strong texture resulting in anisotropic mechanical properties. Intrinsic thermal cycles during consecutive layers deposition, and low thermal conductivity of Ti-6Al-4V (7 W·m/K) facilitate the accumulation of heat leading to steep temperature gradients that favor columnar grain growth. In addition, inevitable porosities found in AM parts are largely attributed to the transfer of trapped atomization gas porosity in feedstock powders, melt pool instabilities, underdeveloped melt pools, and the vaporization of elements.

Several strategies have been developed to overcome the above-mentioned challenges limiting the performance of as-printed alloys. To control the solidification microstructure, high-intensity acoustic vibration has been adopted to achieve columnar to equiaxed transition of prior β-grains via cavitation-assisted nucleation. The addition of solute elements such as Cu, B, and Si to the Ti-6Al-4V have enabled a similar columnar to equiaxed transition by increasing the constitutional supercooling. However, these methods are not universally applicable to different AM techniques or a wide range of materials. For example, acoustic vibration cannot be applied to powder bed fusion (PBF)-AM as it disturbs the powder bed. In addition, finding an effective nucleant remains challenging for several alloys and it changes the composition of the material which might not be desirable for certain applications.

Hot Isostatic Pressing (HIP) has been successfully used to eliminate pores in printed parts. The simultaneous application of heat and pressure leads to the collapsing of pores via plastic deformation-aided diffusion. HIP is now routinely performed on printed samples used for fatigue-critical applications, to shift the defect-initiated failure mode to a microstructural dependent failure initiation. Yet, conventional HIP processes are unable to modify the columnar prior β-grains of AM processed parts.

As disclosed herein, combining the deliberate introduction of large lack of fusion defect (LoF) densities by lowering the laser energy density, followed by HIP to simultaneously modify the microstructure and close pores in printed Ti-6A-4V. Laser power of P=300 W and scanning speed of V=700 mm/s leads to fully dense (FD) deposits of Ti-6A-4V with an average porosity of 0.6±0.5% (FIG. 7A). Five times reduction in energy density (P=100 W, V=1300 mm/s) is implemented to intentionally introduce a high density of sharp and elongated LoF defects resulting in an average porosity of 24±6.4%, as shown in FIG. 7B. The low energy density regime, also known as LoF zone, is unable to establish a melt pool with sufficient depths to bond with previously deposited layers resulting in fusion defects ranging from 50-500 μm.

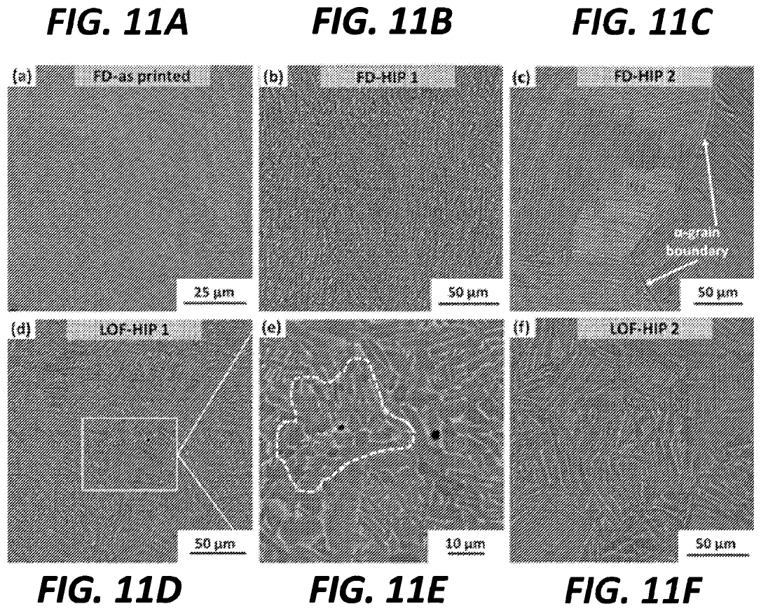

The microstructure of the as-printed specimens (FIGS. 7A and 7B) is characterized by acicular grains, typical of the martensitic phase in Ti alloys. Both LoF and FD samples are subjected to HIP with temperatures below (HIP 1-900° C., 2 h) and above (HIP 2-1000° C., 1 h) the transus temperature of the Ti-6Al-4V alloy (T_{β}=995° C.). After HIP, metastable a′-martensite transforms into α+β microstructure (FIG. 11). The microstructure of the FD-HIP 1 samples is governed solely by Widmanstatten α-laths maintaining the morphology of α′-grains (FIG. 7C). On the other hand, HIP 1 condition led to the formation of a duplex microstructure in the LoF sample while fully eliminating the pores as shown in FIG. 7D. This microstructure has a large population of equiaxed grains with diameters ranging from 2.7-7.2 μm surrounded by elongated α-grains that can extend up to 26.84 μm along their major axis. Post-processing of FD specimens using HIP 2 conditions (1000° C.) resulted in the formation of α colonies with similar crystal orientation within prior β-grains (FIG. 7E). In the absence of LoF defects, the size of α-colonies grow to 183.2±21.7 Applying HIP 2 post-treatment to LoF samples resulted in the duplex microstructure similar to HIP 1 condition but with a much bigger grain size and colonies of 86.1±8.9 as shown in FIG. 7F.

Inverse Pole Figure (IPF) shows that the sub-transus HIP does not alter the strong crystallographic texture of the FD AM processed alloy (FIGS. 8A and 8B) shown by maximum multiples of uniform density (MUD) values between 15-17.5. Martensitic α′-grains and stable α-lamellae exhibit a preferred crystallographic orientation with their c-axis at ˜20.5°-22° with respect to the (0001) pole. A slightly weaker texture in the FD-HIP 1 α-crystals (maximum MUD=9) with their c-axis tilted to 48.3° with respect to the (0001) pole is observed from the ease of slip across stable α/β interfaces enabling the slight rotation of the α-crystals. In contrast, LoF-HIP 1 specimens (FIG. 8D) have a reduced maximum MUD of 6.2 as compared to as-printed FD (17.5) and FD-HIP 1 (15.0) specimens, showing a reduced texture in the duplex microstructure. Two weak texture components representing α-grains with their c-axis at ˜20.3° and 45.1° (FIG. 8D) correspond to similar orientations of α-grains in the as-printed and FD-HIP 1 specimens. IPF maps confirm the formation of α-colonies in the alloy after HIP-ing above the T_{β} (FIGS. 8C and 8E) in both printing regimes with an intensified crystallographic texture.

These findings are in agreement with reconstructed prior β-grains maps (FIGS. 8F-8L), where reduced maximum MUD values of 10.2 (LoF-HIP 1) from 27.5 (FD-HIP 1) represent the ability to modify the microstructure and crystallographic texture of as-printed specimens exclusively in the LoF treated samples. As compared with all other samples, LoF-HIP 1 has smaller, irregularly shaped β-grains with reduced aspect ratios that interrupt the columnar grain growth (FIG. 8K). Regions with small prior β-grains in the β-reconstructed IPF maps outlined in white are directly associated with the group of equiaxed α-grains found in the corresponding α-phase orientation map (FIG. 8D). Given the close relationship between prior β-grains and the nucleation of α-grains, number density of prior β-grains was computed for all specimens. Remarkably, the prior β-grain number density increases by more than 111% in LoF-HIP 1 (17.1×10⁻⁴ μm⁻²) as compared to FD-HIP 1 (8.1×10⁻⁴ μm⁻²) specimens. The effect of closed LoF defects is more pronounced in specimens treated at HIP 2 condition, where the β grain number density sees a five-fold increase in LoF-HIP 2 (8.1×10⁻⁴ μm⁻²) as compared to FD-HIP 2 (1.7×10⁻⁴ μm⁻²). This observation confirms that an initially high density of LoF defects in as-printed conditions led to the nucleation of new grains during HIP.

The role of LoF defects in the formation of a duplex microstructure during HIP in the AM processed Ti alloy is discussed on the basis of two phenomena: (i) the reduction of high energy surfaces, and (ii) a local dislocation-driven recrystallization during the closure of LoF defects.

The healing of LoF defects by the thermo-mechanical HIP treatment is driven by a pressure assisted diffusion process. The abundant free surfaces available in the LoF samples have excess surface energy making them ideal sites for the nucleation of new grains upon heating. Heterogenous nucleation in a solid-state process can be described by the thermodynamic reduction of the activation energy barrier (ΔGₕₒₜ) described as:

ΔGₕₒₜ=−V(ΔG_{V}−ΔG₂)+Aγ−ΔG_{d} (1)

where V is the volume of the nuclei, ΔG_{V} and ΔG_{Z} represent the change in free energy associated with a volume change and misfit strain energy respectively. A is the area of the new interface with an associated interfacial energy γ, and ΔG_{d} is the excess free energy of a defect (i.e., free surface). It is clear from Eq. 1 that the elimination of a fusion defect (free surface) will result in the release of excess free energy (ΔG_{d}), lowering the energy barrier for heterogenous nucleation of stress-free α-grains. In addition to the reduction of surface energy, a secondary mechanism responsible for the nucleation of globular α-grains is proposed to arise from the increase in stored energy (E_{ΔS}) available to drive the recovery and recrystallization process, see FIG. 9.

FIG. 9 shows schematic representation of the dislocation evolution in a LoF specimens during the early stages of HIP treatments of AM processed samples, in accordance with various embodiments. FIG. 9 illustrates formation of duplex microstructure in AM processed Ti-6Al-4V Schematic representation of the dislocation evolution in a LoF specimens during the early stages of HIP treatements: Generation of high density of dislocatiosn ahead of the sharp LoF defect, vacancy migration via interphase boundaries and inherent dislocations derived from the martensitic phases in as-printed conditions. Resulting duplex microstructure of LoF-HIP 1 pecimens after undergoing HIP closure of defects promoting the nucleation and growth of globular α-grains.

In the presence of sharp LoF defects, E_{SS} (Eq. 2) has contributions from dislocations emerging ahead of the LoF defects (E_{Kd}), the accumulation of dislocations at the interphase boundaries due to vacancy diffusion (E_{IB}), and inherent strain energy (Eₛ) associated with the non-equilibrium martensitic microstructure:

E_{SS}=E_{Kd}+E_{IB}+Eₛ (2)

Under the effect of high isostatic pressure, fusion defects with lengths between 200-500 μm and sharp edges of 9-26 μm radius experience a maximum stress between 0.6-1 GPa at the tip of the defect. The localized high stress emits mobile dislocations from the tip of the LoF defect at the initial stage of the HIP process (E_{Kd}). With time, elevated temperatures will induce an in-situ recrystallization process leading to the nucleation of strain-free grains around prior LoF defects. A similar phenomenon has been reported in the healing of cracks in low carbon steel, nickel, and copper under the effect of thermo-mechanical treatments.

In addition, healing of pores via HIP process has been reported to occur via a combination of Nabarro-Herring and Coble creep mechanisms leading to the diffusion of vacancies. The high density of dislocations at the interphase boundaries promotes the diffusion of vacancies along dislocation cores pushing HIP-induced dislocations near the surface of the pores (E_{IB}). The vacancy migration is further intensified due to the existence of higher density of porosities (up to 24%) increasing the stored lattice energy even further. The proposed dislocation-driven recrystallization process is more pronounced in LoF specimens due to the higher availability of stored strain energy as compared to the FD specimen with minimal porosity <0.6% where E_{SS}≅E_{S}.

FIGS. 10A and 10B illustrate plots illustrating mechanical properties of as-printed and AM processed samples, in accordance with various embodiments. Mechanical properties of as-printed and HIP Ti-6Al-4V are illustrated as follows: (a) Average stress-strain response curves of as-printed and HT specimens under tensile loading. Inset shows the log-log plot of true stress vs. true strain of the plastic deformation regime establishing the strain hardening power law relationship. (b) Ashby plot displaying the dramatic improvement in tensile strength and failure strain shown by the engineered duplex microstructures (LoF-HIP 1 and HIP 2) vs. reported conventional cast, and wrought, as-printed and HIP-ed AM Ti alloys. Specifically, tensile experiments were performed on as-printed and HIP-ed specimens (FIGS. 10A and 10B), and their mechanical properties are summarized in Table 1, as disclosed herein.

TABLE 1
Mechanical properties and computed strain hardening
exponent of the as-printed and HIPed specimens.

| | | | Ultimate | | Strain |
|---|---|---|---|---|---|
| | Elastic | Yield | Tensile | Failure | hardening |
| | Modulus | Strength | Strength | strain | exponent |
| Sample | (GPa) | (MPa) | (GPa) | (mm/mm) | (n) |
| FD - as | 119.1 ± 0.8 | 1095.4 ± 56.4 | 1.1 ± 0.06 | 0.05 ± 0.01 | 0.03 ± 2.3E−4 |
| printed | | | | | |
| FD - HIP 1 | 123.8 ± 1.3 | 945.9 ± 30 | 1.01 ± 0.02 | 0.10 ± 0.01 | 0.07 ± 1.2E−4 |
| FD - HIP 2 | 117.6 ± 3.6 | 908.2 ± 10.4 | 0.9 ± 0.01 | 0.12 ± 0.03 | 0.05 ± 0.8E−4 |
| LoF - HIP 1 | 108.16 ± 6.8 | 925.5 ± 21.0 | 1.0 ± 0.03 | 0.20 ± 0.01 | 0.08 ± 2.1E−4 |
| LoF - HIP 2 | 112.1 ± 7.9 | 930.0 ± 30.3 | 1.0 ± 0.03 | 0.19 ± 0.02 | 0.07 ± 1.8E−4 |

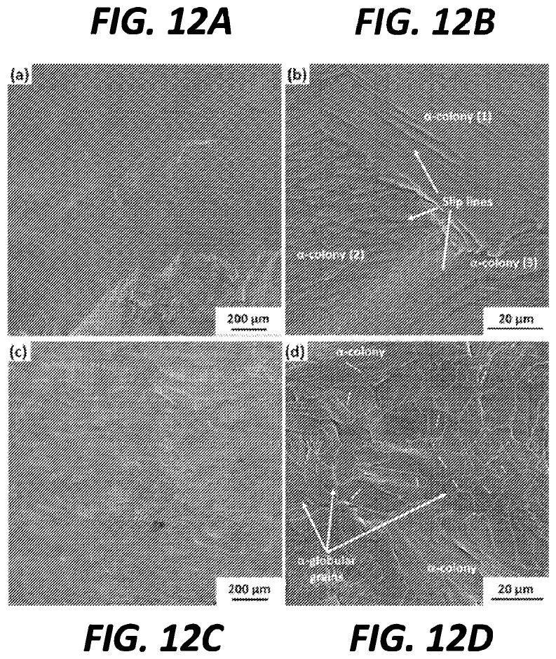

All heat-treated specimens experience a decrease in their yield strength associated with the reduction of dislocation density in the martensitic microstructure and grain growth. This effect is more pronounced in FD-HIP 2 where easy slip transmission across laths with similar crystal orientation occurs (FIGS. 12A and 12B), while all the other heat-treated samples retain a comparable yield strength. Specifically, LoF-HIP 2 shows a similar yield strength to the samples heat treated at sub-transus temperatures. The retained strength is attributed to the smaller α-colony size of 86.1±8.9 μm as compared to FD-HIP 2 (183.2±21.7 μm), and the presence of globular α grains with random crystal orientations to effectively confine the slip length (FIGS. 12C and 12D).

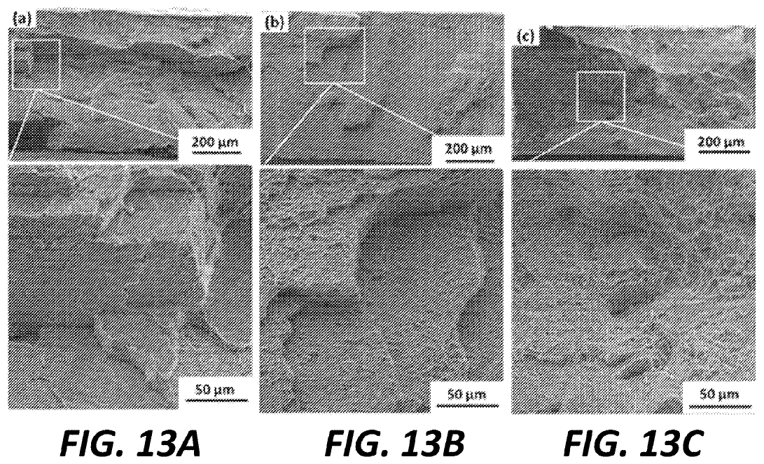

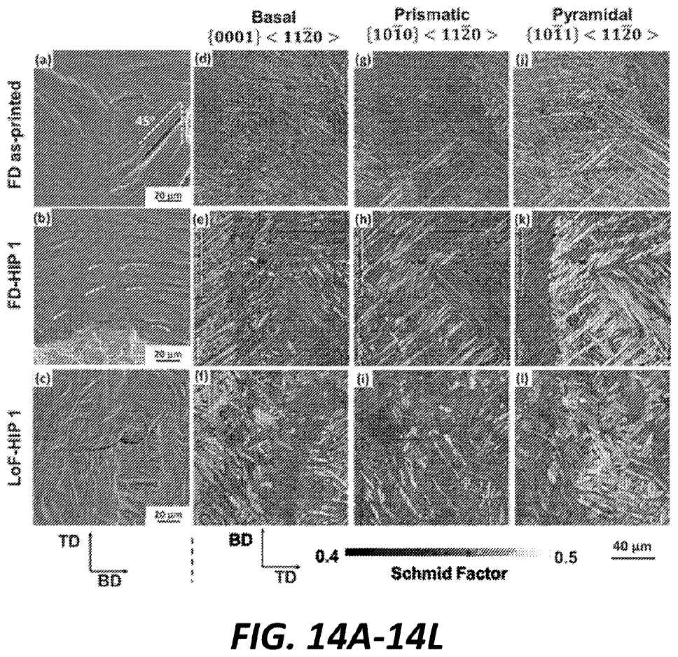

More interestingly, the LoF-HIP 1 and HIP 2 specimens are able to retain their tensile strength (1.0±0.02 GPa) while showing an unprecedented increase in failure strain by up to 300% and 90% as compared to FD as-printed (0.05±0.01) and FD-HIP 1 (0.10±0.01), respectively. Analysis of the fracture surface and surface steps reveals the evolution of deformation mode from a brittle fracture in the as-printed samples to ductile fracture in the LoF-HIP 1 samples as shown by the increasing dimple features (FIGS. 13A-13C) and non-directional surface steps (FIGS. 14A-14L). To understand the mechanism by which these materials break through the strength-ductility trade-off, we study the distribution of potential active slip systems with high Schmid factor in different samples (FIGS. 14A-14L). A higher volume of α-grains with orientations suitable for the activation of basal slip in LoF-HIP 1 specimens, including a large population of the newly nucleated α-globular grains suggest that the emerged defect-free globular α-grains contribute to the extended plasticity (FIGS. 14A-14L). The strain hardening exponent (n) is also computed to provide a measure of the capability of the material to work-harden before strain localization and failure (inset in FIG. 14A). An extremely low n value in the as-printed FD alloy (0.03±2.3×10⁻⁴) shows an early strain localization and therefore limited ductility. In contrast, the higher n value of 0.08±2.1×10⁻⁴ in LoF-HIP 1 specimens as compared to FD-HIP 1 (0.07±1.2×10⁻⁴) and as printed FD counterparts implies the superior capability of the duplex microstructure to effectively work harden the critically stressed areas thus delaying the localization of strain that could lead to premature fracture.

To put the obtained results into context, FIG. 14B compares the tensile strength-ductility of our work with other data available in the literature on SLM and heat treated SLM (SLM-HT), cast and wrought Ti-6Al-4V. It can be observed that the introduction of LoF-induced duplex microstructures is capable of achieving an unprecedented ductility with comparable strength to heat treated SLM data extending the property space of AM Ti alloys. Even more, LoF-HIP 1 and HIP 2 outperform conventional cast and wrought processes that are considered as benchmark to compare the properties of Ti-6Al-4V processed via AM. The newly formed globular α-grains, among prior α′-laths, lack the complex thermal history intrinsic to the additive process enabling a long-range plastic flow with higher degree of dislocation-induced slip plasticity before the formation of dislocation pile-ups or tangles. On the other hand, prior α′-laths inherit a higher dislocation density and unfavorable orientations (FIGS. 14A-14L) that contribute to the material's high strength. It is important to note that the remarkable mechanical performance in the LoF-HIP 1 specimen results from a single thermo-mechanical post process without the inclusion of foreign particles and/or changes in the alloy composition.

This study moves away from the established intuition that LoF defects should always be avoided and demonstrates the possibility to exploit these process inherent defects, in addition to standardized HIP process, as a pathway to print alloys with tailored microstructures and enhanced mechanical properties. The emergence of a duplex microstructure is revealed to be driven by a dislocation-induced recrystallization and reduction of surface energy intensified by the presence of LoF defects. The now duplex microstructure breaks through the ductility-strength tradeoff and exhibits unprecedented plasticity as compared to as-printed, HIP-ed, cast and wrought Ti-6Al-4V without compromising its strength. It is important to highlight that the technique to engineer duplex microstructures presented herein is not restricted to the SLM process. Rather, it can be applied to various AM processes to spatially distribute LoF defects by controlling the energy density during printing. In addition, while the present work focuses on Ti-6Al-4V, the same principles can be applied to a wide-range of metals and alloys suffering from undesirable columnar microstructures in AM including steels, Ni based superalloys and Aluminum alloys.

The gas atomized Ti-6Al-4V powders (Carpenter Technology) with a particle size distribution between 10-45 μm was used in this study. Rectangular blocks of 32 mm in length, 6 mm width and 15 mm height were printed using SLM process. Laser power and scanning velocities representing FD (300 W, 700 mm/s) and LoF (100 W, 1300 mm/s) regimes were chosen from microstructural analysis of a range of process parameters and analysis of their defect density. The additive process was carried out in the OpenAdditive machine with an enclosed chamber and protective Argon atmosphere to prevent oxidation. A constant scanning strategy was implemented for all specimens, consisting of a stripe pattern with a 67° rotation per layer. Layer height and hatch spacing were fixed at 50 μm.

As-printed specimens were subjected to a single HIP treatment using a QIH9 US HIP furnace in an Argon atmosphere. Heat treatments were carried out using sub-transus (HIP 1) and super-transus (HIP 2) temperatures of 900° C. and 1000° C., for periods of 120 min and 60 min, respectively. All specimens were held at a maximum pressure of 100 MPa and were furnace cooled.

As-printed and HIP-ed specimens were sectioned parallel to the build direction for microstructural evaluation. Surfaces were prepared following standard metallographic procedures (grinding and polishing up to 0.05 μm) to remove surface imperfections. Polished surfaces were chemically etched using Kroll's reagent to reveal microstructural features. An Olympus BH-2 (Tokyo, Japan) optical microscope was used to assess the microstructure of as-printed and HIP-ed specimens and ImageJ (NIH, Maryland, USA) was implemented as post-processing tool to quantify grain characteristics. At least 40 grain measurements were acquired to have statistically significant data. Similarly, at least 5 optical micrographs with varying magnifications were utilized for porosity measurements in as-printed conditions. A Tescan Mira3 field emission scanning electron microscope (FE-SEM) equipped with a backscattering detector was used for imaging of polished and fracture surfaces. The morphology of grains, evolution of texture and grain orientation were evaluated via electron backscatter diffraction (EBSD). EBSD measurements were acquired using a QUANTAX EBSD (Bruker, Billerica, MA, USA) apparatus and processed by ATEX open source software.

The β→α′→α phase transformations were studied based on the Burgers relations (110)_{β}//(0001)_{α} and [111]_{β}//[112̅0]_{α}, allowing the reconstruction of prior β-grains from the final α+β microstructure. The automatic reconstruction of parent grains from the EBSD scans of as-printed and HIP-ed specimens were performed using ARGPE software.

Evaluation of the mechanical properties of the as-printed and HIP-ed specimens was carried out under tensile loads using a Deben MT 2000 micro-tensile stage equipped with a 2 kN load cell (Deben UK Ltd, Suffolk, UK). Micro-tensile specimens with a gauge length of 8 mm, width of 2 mm and thickness of 0.8 mm were machined via wire EDM perpendicular to the build direction. Tensile specimens were grinded down to 0.6 mm thickness and polished (0.05 μm colloidal SiC) to capture surface deformation features. Tensile experiments were performed in displacement control mode at an average strain rate of 1.3×10⁻³ s⁻¹. Non-contact real time evolution of strains was captured by a digital image correlation software (GOM, Braunschweig, Germany) from recorded tensile displacements.

The strain hardening exponent (n) is computed as the slope of the logarithmic true stress-strain curves past the onset of plasticity following the power-law relationship:

σ=Kεⁿ (3)

in which, σ is the uniaxial true stress experienced by the specimen under tension, K represents the strength coefficient, ε is the true plastic strain and n is the strain hardening exponent.

FIGS. 11A-11F illustrate backscatter electron images of AM processed samples, in accordance with various embodiments. FIGS. 11A-11F illustrate microstructural and phase characteristics of AM and HIP-ed Ti6Al4V via Backscatter electron images demonstrating distribution of (a) fine acicular α′ phases in FD as-printed, (b) stabilized α-phase (darker contrast) and β-phase residing at the grain boundaries (lighter contrast) in FD-HIP 1, (c) α-phases colonies in the form of elongated laths surrounded byα-grain boundaries, (d,e) duplex microstructure of the LoF-HIP 1 showing recrystallized globular α-grains around LoF defects surrounded by lamellar α-laths retained from the AM process, (f) restricted growth of α-colonies in super-transus HIP LoF specimens (LoF-HIP2). Errors bars represent standard deviation among the 4 specimens studied for each experimental condition.

FIGS. 11A-11F shows the backscatter electron micrograph image of as-printed fully dense (FD) and lack of fusion (LoF) specimens before and after undergoing sub- and super-transus hot isostatic pressing (HIP). FD as-printed microstructure is characterized by fine acicular α′ martensite corresponding to non-equilibrium phases developed during the rapid solidification of additive manufacturing (FIG. 11A).

At sub-transus HIP (HIP 1, 900° C., 100 MPa, 2 h), α′-martensite stabilizes and results in α-laths (shown in dark contrast) with β-phase at the grain boundaries (light contrast) as shown in FIG. 11B. Higher temperatures past the β-transus temperature of the Ti-6Al-4V alloy (HIP 2, 1000° C., 100 MPa, 1 h) results in the nucleation and growth of elongated α-laths sharing a single crystal orientation in each colony. Colonies are shown to be separated via α-grain boundaries, known to be detrimental to the mechanical performance of the alloy. The introduction of LoF defects in the as-printed microstructure results in the nucleation and growth of strain free α-grains with globular morphology via recrystallization after HIP 1 schedule (See enclosed regions in FIGS. 11D and 11E). Super-transus HIP of LoF specimens retains the duplex microstructure and growth of α-colonies is restricted by newly nucleated grains around prior defect surfaces (FIG. 11F).

Deformation behavior of FD and LoF specimens HIP-ed at super-transus temperature is described herein. FIGS. 12A-12D illustrate electron microscope images of AM processed samples, in accordance with various embodiments. FIGS. 12A-12D illustrate the role of α-colonies on deformation behavior Post-mortem investigation of surface steps of FD-HIP 2 specimens showing (a) the macroscale (b) detailed view of deformation governed by formation of slip traces predominantly in a single direction within a single α-colony and change of slip direction at the intersection of α colonies with different crystal orientations; (c) LoF-HIP 2 showing macroscale deformation, (d) slip traces along a single direction across multiple α-laths in colonies, intersecting globular α-grains with slip traces in random orientations.

FIGS. 12A-12D reveal the role of α-colonies on deformation behavior of samples HIP-ed at super-transus temperature. FIGS. 12A and 12B show the formation of slip traces in a single direction within α-colonies (183.2±21.7 μm), and their intersection at the α-grain boundaries (corresponding to prior β grain boundaries) where there is a change in crystal orientation. Easy transfer of slip across α-laths within a single colony is responsible for the decrease in the yield and tensile strength of the FD-HIP 2 samples with respect to all the other samples. In contrast, LoF-HIP 2 (FIGS. 12C and 12D) has smaller α-colony size (86.1±8.9 μm) surrounded by globular α-grains with random slip traces which are effective in blocking dislocation motions and result in no further decrease in yield strength with respect to HIP 1 samples.

Evaluation of the fracture surface perpendicular to the loading direction reveals the presence of cleavage facets in the as-printed specimens indicative of a brittle failure at the macroscale (FIG. 13A).

FIGS. 13A-13C illustrate electron microscope images of a fracture surface of AM processed samples, in accordance with various embodiments. FIGS. 13A-13C illustrate fracture surface in AM and HIP-ed Ti-6Al-4V. As shown in the scanning electron micrographs, the fracture surfaces perpendicular to the tensile load direction of (a) FD as-printed specimens showing sharp cleavage features characteristic of macroscopic brittle fracture, detailed view shows sharp steps with featureless surface, (b) FD-HIP 1 with planar fracture surface, detailed view shows the limited plasticity encountered after sub-transus HIP revealed by limited dimple like features, (c) LoF-HIP 1 shows irregular features in the reduced cross-sectional area due to extensive plasticity and necking achieved prior to fracture, detailed view shows a combination of dimple features and some clean facets characteristic of the ductile fracture in the duplex microstructure.

The analysis of surface steps shows a set of steep steps along α′ laths that are oriented 45° with respect to the tensile direction (TD) near the fracture surface (FIG. 14A). The preferred orientation of the α′ laths along the plane of maximum shear stress is responsible for the localization of strains in this region leading to the nucleation of voids and premature failure. This is in agreement with a prior study by our group, where in-situ tensile studies with concurrent micro digital image correlation (DIC) revealed the localization of strains in large aspect ratio primary α′ laths. These α′ laths exhibited high Schmidt factors in the basal and prismatic slip systems suggesting their easy activation upon tensile loading leading to the nucleation of voids, their coalescence and final failure.

Stabilization of martensitic phases in the FD samples subjected to sub-transus HIP resulted in a slight change in the texture of the α-crystals (c-axis rotation from 22° to) 48°. These microstructural and crystallographic changes enabled a limited enhancement in the failure strain (ε_{f}=10%). Investigation of the fracture surface shows cleavage facets with limited dimple features on the surface (FIG. 13B). Surfaces parallel to the TD (FIG. 14B) shows steep surface steps originating at the α/β interphase boundaries arranged in discontinuous semi-circles with an origin directed to the fracture point. Therefore, the plasticity in FD-HIP 1 specimens is mainly limited to plasticity at the interphase boundaries.

FIGS. 14A-14L illustrate images for surface characterization of AM processed samples, in accordance with various embodiments. FIGS. 14A-14L reveal deformation mechanism of AM fabricated Ti-6Al-4V via Post-mortem surface characterization of (a) as-printed specimens showing shearing-type deformation initiating at primary α′-laths. (b) Limited plasticity in FD-HIP 1 specimens characterized by radial surface steps at the α/β interphase boundaries. (c) Extended plasticity in the LoF-HIP 1 specimens can be observed by high density of non-directional surface steps. (d-1) Schmid factor maps of basal, prismatic and pyramidal slip systems. Grains with a Schmid factor of 0.4-0.5 are shown in gray-scale.

The large presence of non-directional surface steps in LoF-HIP 1 is indicative of the homogenous deformations enabled by the presence of globular grains with no preferential crystallographic orientation (FIG. 14C). The considerable degree of surface damage sustained by the specimen and dimple structure on the fracture surface (FIG. 13C) is in agreement with the higher strain hardening (n) exponent computed for LoF-HIP 1 (0.08) as compared to the as-printed and FD-HIP 1 counterparts.

The Schmid factor maps corresponding to prismatic {101̅0}<112̅0>, basal {0001}<112̅0> and pyramidal {101̅1}<112̅0> as slip systems are computed and shown in FIGS. 14D-14L. Computations were performed assuming the tensile axis is perpendicular to the build direction. Only grains exhibiting Schmid factors between 0.4-0.5 are shown in gray-scale, representing crystals with an orientation suitable for the activation of the corresponding slip systems. Area fractions describing the distribution of basal, prismatic and pyramidal slip systems in the as-printed microstructures are 47%, 55%, and 73%, respectively. A similar distribution is determined in FD-HIP 1, with area fractions of 44% basal, 53% prismatic and 78% pyramidal. In contrast, LoF-HIP 1 shows an increase in the area fraction of grains with a preferred basal slip of 62%, including a large population of the newly nucleated α-globular grains. A comparable distribution corresponding to prismatic slip of 43% and 73% pyramidal is attributed to the retained textured of α-laths. Basal and prismatic are main activated slip systems at room temperature in the α-Ti phase due to their low critical resolved shear stress (CRSS). A higher volume of α-grains with a preferred orientation suitable for the activation of basal slip in LoF-HIP 1 specimens contributes to the extended plasticity in these samples.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

### RECITATATION OF EMBODIMENTS

Embodiment 1: A method of manufacturing a metal alloy, comprising: printing a metal product having a plurality of columnar grains; performing a thermo-mechanical treatment on the printed metal product; and forming the metal alloy having a duplex microstructure.

Embodiment 2: The method of embodiment 1, wherein the plurality of columnar grains comprises a high density of fusion defects.

Embodiment 3: The method of embodiments 1 or 2, wherein a size of the fusion defects ranges between about 50 μm and 500 μm.

Embodiment 4: The method of any of embodiments 1-3, wherein the printed metal product comprises an average porosity ranging between about 15% and 32%.

Embodiment 5: The method of any of embodiments 1-4, wherein the thermo-mechanical treatment comprises hot isostatic pressing (HIP).

Embodiment 6: The method of any of embodiments 1-5, wherein a first portion of the duplex microstructure comprises a portion of the plurality of columnar grains in a form of laths and wherein a second portion of the duplex microstructure comprises globular grains.

Embodiment 7: The method of any of embodiments 1-6, wherein the thermo-mechanical treatment of the printed metal product transforms at least a portion of the plurality of columnar grains into globular grains.

Embodiment 8: The method of embodiment 7, wherein a percentage of the globular grains in the duplex microstructure that are transformed from the at least a portion of the plurality of columnar grains comprises up to about 110% of the globular grains initially comprised in the printed metal product.

Embodiment 9: The method of any of embodiments 1-8, wherein the at least a portion of the plurality of columnar grains is transformed into the globular grains via a dislocation-driven recrystallization process during the thermo-mechanical treatment.

Embodiment 10: The method of any of embodiments 1-9, wherein at least a portion of the globular grains is substantially defect-free.

Embodiment 11: The method of any of embodiments 1-10, wherein the printing of the metal product is performed via additive manufacturing.

Embodiment 12: The method of any of embodiments 1-11, wherein the additive manufacturing comprises a laser-based selective laser melting or a plasma-based additive manufacturing.

Embodiment 13: The method of any of embodiments 1-12, wherein the printing of the metal product is performed at a low energy density to produce the metal product within a lack-of-fusion regime during the additive manufacturing.

Embodiment 14: The method of any of embodiments 1-13, wherein the metal alloy comprises at least one of steel, Ni-based superalloys, Al-based alloys, or Ti-based alloys.

Embodiment 15: The method of any of embodiments 1-14, wherein the metal alloy comprises a titanium aluminum vanadium alloy.

Embodiment 16: The method of embodiment 15, wherein the titanium aluminum vanadium alloy is Ti-6Al-4V.

Embodiment 17: The method of any of embodiments 1-16, wherein the metal alloy comprises a failure strain of at least about 15% or a failure strain in a range between about 15% to about 20%.

Embodiment 18: The method of any of embodiments 1-17, wherein the metal alloy comprises a failure strain between about 90% and 300% of the printed metal product.

Embodiment 19: The method of any of embodiments 1-18, wherein the metal alloy comprises a tensile strength substantially similar to that of the printed metal product.

Embodiment 20: The method of any of embodiments 1-19, wherein the metal alloy comprises a comparable tensile strength of the printed metal product while comprising a failure strain of up to about 300% of the printed metal product.

Embodiment 21: A method of manufacturing a metal alloy, comprising: printing a metal product having a stack of individual metal layers via a laser-based additive manufacturing tool, wherein a laser energy density of the tool is configured such that two adjacent individual metal layers do not bond to one another; and performing a thermo-mechanical treatment on the printed metal product to produce the metal alloy.

Embodiment 22: The method of embodiment 21, wherein the printed metal product comprises a plurality of columnar grains having a high density of fusion defects.

Embodiment 23: The method of embodiments 21 or 22, wherein a size of the fusion defects ranges between about 50 μm and about 500 μm.

Embodiment 24: The method of any of embodiments 21-23, wherein the printed metal product comprises an average porosity ranging between about 15% and about 32%.

Embodiment 25: The method of any of embodiments 21-24, wherein the thermo-mechanical treatment comprises hot isostatic pressing (HIP).

Embodiment 26: The method of any of embodiments 21-25, wherein the metal alloy comprises a duplex microstructure.

Embodiment 27: The method of embodiment 26, wherein a first portion of the duplex microstructure comprises a plurality of columnar grains and wherein a second portion of the duplex microstructure comprises globular grains.

Embodiment 28: The method of any of embodiments 21-27, wherein the thermo-mechanical treatment of the printed metal product transforms at least a portion of the plurality of columnar grains into a portion of the globular grains.

Embodiment 29: The method of any of embodiments 21-28, wherein a percentage of the globular grains in the duplex microstructure that are transformed from the at least a portion of the plurality of columnar grains comprises up to about 110% of the globular grains initially comprised in the printed metal product.

Embodiment 30: The method of any of embodiments 21-29, wherein the at least a portion of the plurality of columnar grains is transformed into the globular grains via a dislocation-driven recrystallization process during the thermo-mechanical treatment.

Embodiment 31: The method of any of embodiments 21-30, wherein at least a subset of the globular grains is substantially defect-free.

Embodiment 32: The method of any of embodiments 21-31, wherein the printing of the metal product is performed within a lack-of-fusion regime during the additive manufacturing.

Embodiment 33: The method of any of embodiments 21-32, wherein the metal alloy comprises at least one of steel, Ni-based superalloys, Al-based alloys, or Ti-based alloys.

Embodiment 34: The method of any of embodiments 21-33, wherein the metal alloy comprises a titanium aluminum vanadium alloy.

Embodiment 35: The method of embodiment 34, wherein the titanium aluminum vanadium alloy is Ti-6Al-4V.

Embodiment 36: The method of any of embodiments 21-35, wherein the metal alloy comprises a failure strain of at least about 15% or a failure strain in a range between about 15% to about 20%.

Embodiment 37: The method of any of embodiments 21-36, wherein the metal alloy comprises a failure strain between about 90% and about 300% of the printed metal product.

Embodiment 38: The method of any of embodiments 21-37, wherein the metal alloy comprises a tensile strength substantially similar to that of the printed metal product.

Embodiment 39: The method of any of embodiments 21-38, wherein the metal alloy comprises a comparable tensile strength of the printed metal product while comprising a failure strain of up to about 300% of the printed metal product.

Embodiment 40: The method of any of embodiments 21-39, wherein the printed metal product comprises a plurality of laths and equiaxed grains and wherein the metal alloy comprises more equiaxed grains than the printed metal product.

Embodiment 41: An alloy having a duplex microstructure comprising a plurality of laths and a plurality of globular grains, wherein the plurality of laths is formed via additive manufacturing and a subset of the plurality of globular grains are formed via a thermo-mechanical treatment.

Embodiment 42: The alloy of embodiment 41, wherein the alloy comprises one of steel, Ni-based superalloys, Al-based alloys, or Ti-based alloys.

Embodiment 43: The alloy of embodiments 41 or 42, wherein the alloy comprises a titanium aluminum vanadium alloy.

Embodiment 44: The alloy of any of embodiments 41-43, wherein the titanium aluminum vanadium alloy is Ti-6Al-4V.

Embodiment 45: The alloy of any of embodiments 41-44, wherein at least the subset of the plurality of globular grains are surrounded by a portion of the plurality of laths.

Embodiment 46: The alloy of any of embodiments 41-45, wherein the additive manufacturing comprises a laser-based selective laser melting or a plasma-based additive manufacturing.

Embodiment 47: The alloy of embodiment 46, wherein the forming of the plurality of laths is performed via the laser-based selective laser melting using a low laser energy density within a lack-of-fusion regime of the additive manufacturing.

Embodiment 48: The alloy of any of embodiments 41-47, wherein the thermo-mechanical treatment comprises hot isostatic pressing (HIP).

Embodiment 49: The alloy of any of embodiments 41-48, wherein the plurality of laths comprises a plurality of columnar grains having a high density of fusion defects and wherein at least a portion of the plurality of globular grains is substantially defect-free.

Embodiment 50: The alloy of any of embodiments 41-49, wherein the alloy comprises a failure strain of at least about 15% or a failure strain in a range between about 15% to about 20%.

Embodiment 51: A method of manufacturing an alloy, comprising: forming a pre-product having a first plurality of columnar grains and a first plurality of globular grains; performing a thermo-mechanical treatment of the pre-product; and transforming some of the first plurality of columnar grains of the pre-product into additional globular grains to obtain the alloy comprising a second plurality of columnar grains and a second plurality of globular grains.

Embodiment 52: The method of embodiment 51, wherein the second plurality of columnar grains comprises fewer columnar grains that the first plurality of columnar grains, and the second plurality of globular grains comprises more globular grains than the first plurality of globular grains.

Embodiment 53: The method of embodiments 51 or 52, wherein the first plurality of columnar grains comprises a high density of fusion defects.

Embodiment 54: The method of any of embodiments 51-53, wherein a size of the fusion defects ranges between about 50 μm and about 500 μm.

Embodiment 55: The method of any of embodiments 51-54, wherein the pre-product comprises an average porosity ranging between about 15% and about 32%.

Embodiment 56: The method of any of embodiments 51-55, wherein the thermo-mechanical treatment comprises hot isostatic pressing (HIP).

Embodiment 57: The method of any of embodiments 51-56, wherein the additional globular grains comprises up to about 110% of the first plurality of globular grains.

Embodiment 58: The method of any of embodiments 51-57, wherein the transforming of some of the first plurality of columnar grains of the pre-product into the additional globular grains occurs via a dislocation-driven recrystallization process during the thermo-mechanical treatment.

Embodiment 59: The method of any of embodiments 51-58, wherein at least a portion of the second plurality of the globular grains is substantially defect-free.

Embodiment 60: The method of any of embodiments 51-59, wherein the forming of the pre-product is performed via additive manufacturing.

Embodiment 61: The method of embodiment 60, wherein the additive manufacturing comprises a laser-based selective laser melting or a plasma-based additive manufacturing.

Embodiment 62: The method of any of embodiments 51-61, wherein the forming of the pre-product is performed at a low energy density to produce the pre-product within a lack-of-fusion regime during the additive manufacturing.

Embodiment 63: The method of any of embodiments 51-62, wherein the alloy comprises one of steel, Ni-based superalloys, Al-based alloys, or Ti-based alloys.

Embodiment 64: The method of any of embodiments 51-63, wherein the alloy comprises a titanium aluminum vanadium alloy.

Embodiment 65: The method of embodiment 64, wherein the titanium aluminum vanadium alloy is Ti-6Al-4V.

Embodiment 66: The method of any of embodiments 51-65, wherein the alloy comprises a failure strain of at least about 15% or a failure strain in a range between about 15% to about 20%.

Embodiment 67: The method of any of embodiments 51-66, wherein the alloy comprises a failure strain between about 90% and about 300% of the pre-product.

Embodiment 68: The method of any of embodiments 51-67, wherein the alloy comprises a tensile strength substantially similar to that of the pre-product.

Embodiment 69: The method of any of embodiments 51-68, wherein the alloy comprises a comparable tensile strength of the pre-product while comprising a failure strain of up to about 300% of the pre-product.

Embodiment 70: The method of any of embodiments 51-69, wherein the alloy comprises the second plurality of columnar grains in a form of laths, and at least a subset of the second plurality of globular grains are surrounded by at least a portion of the laths.

Embodiment 71: A method of manufacturing, comprising: printing a metal product via an additive manufacturing process controlled to form in a first plurality of predetermined regions, via input of energy of a first energy density, columnar grain growth of metal feedstock materials and to form in a second plurality of predetermined regions, via input of energy of a second energy density lower than that of the first energy density, lack of fusion defects; and performing a thermo-mechanical treatment on the printed metal product to form a duplex microstructure in the metal product, wherein the first energy density comprises a single value or comprises a selected value within a range of predetermined values, and wherein the second energy density comprises a single value or comprises a selected value within a range of predetermined values.

Embodiment 72: The method of embodiment 71, wherein the duplex structure comprises globular α-grains and elongated α-laths.

Embodiment 73: The method of embodiments 71 or 72, wherein the lack of fusion defects formed in the second plurality of predetermined regions yield a porosity of greater than about 24% in the metal product.

Embodiment 74: The method of embodiments 71-73, wherein the second plurality of predetermined regions are spatially distributed throughout the metal product to correspondingly distribute the lack of fusion defects.

Embodiment 75: The method of embodiments 71-74, wherein the lack of fusion defects comprises one or more sizes ranging between about 50-500 μm.

Embodiment 76: The method of embodiments 71-75, wherein the metal feedstock materials comprise one or more metal powders and/or one or more metal alloy powders.

Embodiment 77: An additive manufacturing system, comprising: a print controller to control an additive manufacturing process, the print controller being configured to fuse metal feedstock materials in a first plurality of predetermined regions of a workpiece via input of energy of a first energy density from an energy input device and configured to form lack of fusion defects in the workpiece in a second plurality of predetermined regions via input of energy of a second energy density from the energy input device lower than that of the first energy density, wherein the first energy density comprises a single value or comprises a selected value within a range of predetermined values, and wherein the second energy density comprises a single value or comprises a selected value within a range of predetermined values.

Embodiment 78: The additive manufacturing system of embodiment 77, wherein the print controller is configured to cause fusion of the metal feedstock materials in the first plurality of predetermined regions of the workpiece via input of energy of the first energy density to form columnar grains.

Embodiment 79: The additive manufacturing system of embodiments 77 or 78, wherein the print controller is configured to cause formation of lack of fusion defects in the workpiece in the second plurality of predetermined regions via input of energy of the second energy density at a density in the workpiece corresponding to an average porosity between about 15% and 32%.

Embodiment 80: The additive manufacturing system of any of embodiments 77-79, wherein the print controller is configured to form lack of fusion defects sized between about 50 μm and 500 μm.

Embodiment 81: The additive manufacturing system of any of embodiments 77-80, wherein the energy input device comprises one or more lasers.

Embodiment 82: The additive manufacturing system of any of embodiments 77-81, wherein the metal feedstock materials comprise steel, Ni-based superalloys, Al-based alloys, Ti-based alloys, a titanium aluminum vanadium alloy and/or Ti-6Al-4V.

1. A method of manufacturing an alloy, comprising:
forming a pre-product having a first plurality of columnar grains and a first plurality of globular grains;
performing a thermo-mechanical treatment of the pre-product; and
transforming some of the first plurality of columnar grains of the pre-product into additional globular grains to obtain the alloy comprising a second plurality of columnar grains and a second plurality of globular grains.

2. The method of manufacturing according to claim 1, wherein the second plurality of columnar grains comprises fewer columnar grains that the first plurality of columnar grains, and the second plurality of globular grains comprises more globular grains than the first plurality of globular grains.

3. The method of manufacturing according to claim 1, wherein the first plurality of columnar grains comprises a high density of fusion defects.

4. The method of manufacturing according to claim 3, wherein a size of the fusion defects ranges between about 50 μm and about 500 μm.

5. The method of manufacturing according to claim 1, wherein the pre-product comprises an average porosity ranging between about 15% and about 32%.

6. The method of manufacturing according to claim 1, wherein the thermo-mechanical treatment comprises hot isostatic pressing (HIP).

7. The method of manufacturing according to claim 1, wherein the transforming of some of the first plurality of columnar grains of the pre-product into the additional globular grains occurs via a dislocation-driven recrystallization process during the thermo-mechanical treatment.

8. The method of manufacturing according to claim 1, wherein the alloy comprises one of steel, Ni-based superalloys, Al-based alloys, or Ti-based alloys.

9-20. (canceled)

21. The method of manufacturing according to claim 1, wherein the alloy comprises a titanium aluminum vanadium alloy.

22. The method of manufacturing according to claim 21, wherein the titanium aluminum vanadium alloy is Ti-6Al-4V.

23. The method of manufacturing according to claim 1, wherein the additional globular grains comprise up to 110% of the first plurality of globular grains.

24. The method of manufacturing according to claim 1, wherein at least a portion of the second plurality of the globular grains is defect-free.

25. The method of manufacturing according to claim 1, wherein the forming of the pre-product is performed via additive manufacturing.

26. The method of manufacturing according to claim 23, wherein the additive manufacturing comprises a laser-based selective laser melting or a plasma-based additive manufacturing.

27. The method of manufacturing according to claim 23, wherein the forming of the pre-product is performed at a low energy density to produce the pre-product within a lack-of-fusion regime during the additive manufacturing.

28. The method of manufacturing according to claim 1, wherein the alloy has a failure strain of at least 15%.

29. The method of manufacturing according to claim 1, wherein the alloy has a failure strain between 90% and 300% of a failure strain of the pre-product.

30. The method of manufacturing according to claim 1, wherein the alloy comprises the second plurality of columnar grains in a form of laths, and at least a subset of the second plurality of globular grains are surrounded by at least a portion of the laths.

31. The method of manufacturing according to claim 1, wherein a first difference between a failure strain of the alloy and a failure strain of the pre-product is greater than a second difference between a tensile strength of the alloy and a tensile strength of the pre-product.

32. (canceled)

33. An alloy manufactured according to the method of claim 1.
